(19) United States
(12) Patent Application Publication
(10) Pub. No.: US 2001/0021934 A1
(43) Pub. Date: Sep. 13, 2001

(54) Processing device for searching information in one language using search query in another language, and recording medium and method thereof

(76) Inventor: Takeshi Yokoi, Yokohama (JP)

Correspondence Address: STAAS & HALSEY LLP, 700 11TH STREET, NW, SUITE 500, WASHINGTON, DC, 20001, US

(21) Appl. No.: 09/794,060

(22) Filed: Feb. 28, 2001

(30) Foreign Application Priority Data
Mar. 8, 2000 (JP) 2000-64205

(51) Int. Cl. G06F 15/00

(52) U.S. Cl. 707/500

(57) ABSTRACT

The present invention pertains to technology which makes possible searching information on web pages that is in different languages with data input in one's own language. The present invention provides a processing device in communication with the Internet, the processing device executing a read processing module (e.g., a web browser) processing web pages being supplied or provided by a server in communication with the Internet and displaying the web pages on a display unit. The data input on a web page displayed by the read processing module is examined and a determination is made whether the data input requires a specific process. Based on the result of that judgment, the specific process is performed on the input data and the results of the specific process are used in processing requests of the web page, such as processing requests to be sent to the server. The server may be a search server and the specific process may be a translation process, so that a translation process is executed on the input data and the results of the translation are used in a processing request sent to the search server.

### CROSS-REFERENCE TO RELATED APPLICATION

This application is related to and claims priority to Japanese Patent Application No. 2000-64205, filed Mar. 8, 2000 in Japan, the contents of which are incorporated herein by reference.

### BACKGROUND OF THE INVENTION

1. Field of the Invention

This invention pertains to technology which makes effective use of public web pages and data input in one's native language. In particular, the present invention pertains to technology which makes possible searching information that is in different languages with data input in one's own language when using public web pages, such as Internet, or when using accessible web pages in a system, such as Intranet.

2. Description of the Related Art

The Internet, including the World Wide Web (WWW), is becoming quite diffuse and ubiquitous. In particular, many WWW servers now operate around the world containing all types of web pages. There are also many web pages made for searching (hereafter called “search engines”) which are employed, for example, by users or devices, for searching information about content of Internet servers or WWW servers and obtaining information that the users or device desire.

Search engines like those above perform searches of databases using keywords contained in search requests, for example, from users using web browsers. Generally, these are relational databases created by accessing all sorts of web pages to collect content and extract words from the content, such as the web page URL, the title or the summary of its contents, to use as keys.

It follows then that keywords input by the user that don't match the database keys are deemed not be contained in the web pages that are sought by a search engine. However, this phenomenon happens frequently when a user employs his or her native language and it is different from the language used in an overseas search engine or a search engine using a foreign language and is due to the fact that the user is unable to correctly specify the words or phrases corresponding to those in other languages. In this way, differences between languages have served as an obstacle to searching for desired information.

In order to eliminate this phenomenon, a technology for translating the words and phrases input by a user into the language used in the database was disclosed in Japanese Unexamined Patent Application Publication No. H10 32883.

The system in this Japanese Unexamined Patent Application Publication No. H10 32883 is composed of a client computer, an application server and database servers. The configuration used in this system, specifies in the client computer the language of the search conditions (i.e., keywords) for the databases to be searched. After the search conditions are input, the specified information and input data are sent to an application server. Based on the language of the database to be searched as specified by the language selected for the search conditions, the application server judges whether there is a need for translation and if it is judged that the translation process is necessary, the search conditions are translated to the language of the database to be searched.

The application server uses the translated search conditions to execute or submit a search request to the data server storing the database to be searched in the language specified and, using the search conditions, the data server performs a search of the database to be searched. These processes accommodate searching using a large number of target languages.

Japanese Unexamined Patent Application Publication No. H10 87752 also discloses another type of conventional technology. The Japanese Unexamined Patent Application Publication No. H10 87752 discloses a technology that uses a client-server system, in which the server is also equivalent to a search engine and keywords entered by the client are translated by the server system and a search is processed. The server system in Japanese Unexamined Patent Application Publication No. H10 87752 compiles in advance home page (web page) data to be searched and manages keywords, URLs, domains, language translations and index information corresponding thereto. Search conditions, such as keywords, search language and search domains, are input into the client and sent to the server system. The server system translates the keywords received from the client into the specified language and searches the index information. Home page information and the translated keywords corresponding to the search conditions are transferred to the client as search results.

The disclosed systems improve the efficiency of search processing using the user's native language. In particular, such conventional technology allows for efficient search processing by having the user input keywords in his or her native language.

However, these conventional technologies perform the aforementioned translation processes on the server and require the user to input necessary items, such as search language. Further, the input screens displayed on the client (browser) differ from the standard web pages provided by the search engines. Therefore, the administrator of such server according to the conventional technology would be required to design and create such input screens. And, based on requests from individual users, server administrators would sometimes have to add or modify the search engines presented. The conventional technology increases the burden of server administrators and further it is difficult to respond to the individual requests of the users.

Further, in the conventional technology when running a translation process on the server system (search engine), it is difficult to effectively use the same keywords and many search engines, because each search engine runs its own translation and search processes so that each search engine is likely to or would return different search results. As a result, it is difficult for users to obtain the information they desire.

Therefore, users are forced to use specific search engines having a translation processing function when searching for web pages whose contents are written in a language different from the language that the user employs to input data, such as keywords. However, to effectively use different search engines (i.e., efficiently obtain desired information), keywords would have to be entered in the same language as the content of the pages that the user is searching. For these reasons, the conventional technology does not accommodate using data input in the user's native language to efficiently search the web pages provided, for example, by many of the publicly available search engines.

### SUMMARY OF THE INVENTION

Therefore, with the above types of problems in mind, it is an object of the present invention to provide a technology that allows for efficient data processing when data is input in a native language, for example, a user's native language, to search many publicly available information on the Internet, such as Internet web pages, or accessible web pages, in other languages. More specifically, an object of the present invention is to provide a technology allowing efficient searching of Internet web pages provided by many publicly available search engines in different languages, using keywords that are input in a user's native language.

Another object of the present invention is to efficiently process data entered in a native language to search publicly available information on the Internet, for example Internet web pages, or accessible web pages, in another language without modification of such information to be searched. In particular, another object of the present invention is to enter keywords in one's native language to run efficient search processes of web pages provided by many different publicly available search engines in different languages around the world without making any changes to the search engines.

The aforementioned objects are attained by providing a system, such as a computer or device, in communication with the Internet or on the Internet, the computer or device executing a read processing module (e.g., a web browser) processing web pages being supplied or provided by a server connected to (in communication with) the Internet and displaying the web pages on a display unit. In the present invention, the data input on a web page displayed by the read processing module is examined and a determination is made whether the data input requires a specific process. Based on the result of that judgment, the specific process is run or performed on the input data and the results of the specific process are used in processing requests of the web page, such as a processing request to be sent to the server. Further, the server may be a search server and as the specific process a translation process is executed on the input data and the results of the translation are used in a processing request sent to the search server. Further, in the present invention a desired search serve may be selected from among several search servers and a web page of the selected search server is processed and displayed by the read processing module. Further, search servers may be added or deleted for selection.

In particular, the aforementioned objects are attained by providing a device connected to a network and displaying web pages supplied from a server connected to the network, the device comprising a processor, to determine whether to perform a process on data input into a web page by a user, to perform the process responsive to the determination, and to send to the server processing requests of the web page using results of the process.

Further, the aforementioned objects are attained by providing a processing device connected to a network and equipped with a browsing unit that displays supplied web pages on a display unit of the processing device, the processing device comprising a detection unit to communicate with the browsing unit and to detect whether a specific process is required for data input into a web page displayed by the browsing unit. The processing device also comprising a processing unit to communicate with the detection unit and to execute specific processes on the data input into the web page responsive to a detection result by the detection unit and a control unit to communicate with the processing unit and to use results of the specific processes to process requests from the web page.

Further, the objects of the present invention can be attained by recording a program onto a recording medium or unit readable by computers, including devices, in communication with the Internet, the program executing the aforementioned processes of the present invention on the computers, including the devices.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a diagram showing the network environment used and the hardware configuration of a computer in the present invention.

FIG. 2 is a diagram showing a screen display example of the present invention.

FIG. 3 is a diagram showing a search engine settings dialogue box.

FIG. 4 is a diagram (1 of 5) showing a screen display example of the search page settings wizard.

FIG. 5 is a diagram (2 of 5) showing a screen display example of the search page settings wizard.

FIG. 6 is a diagram (3 of 5) showing a screen display example of the search page settings wizard.

FIG. 7 is a diagram (4 of 5) showing a screen display example of the search page settings wizard.

FIG. 8 is a diagram (5 of 5) showing a screen display example of the search page settings wizard.

FIG. 9 is a flow chart for the search page setting wizard program segment of the present invention.

FIG. 10 is a data structure diagram of the search engine information.

FIG. 11 is a flow chart (1 of 2) for the application program of the present invention.

FIG. 12 is a flow chart (2 of 2) of the application program of the present invention.

### DESCRIPTION OF THE PREFERRED EMBODIMENTS

Reference will now be made in detail to the preferred embodiments of the present invention, examples of which are illustrated in the accompanying drawings, wherein like reference numerals refer to the like elements throughout. The embodiments are described below to explain the present invention by referring to the figures.

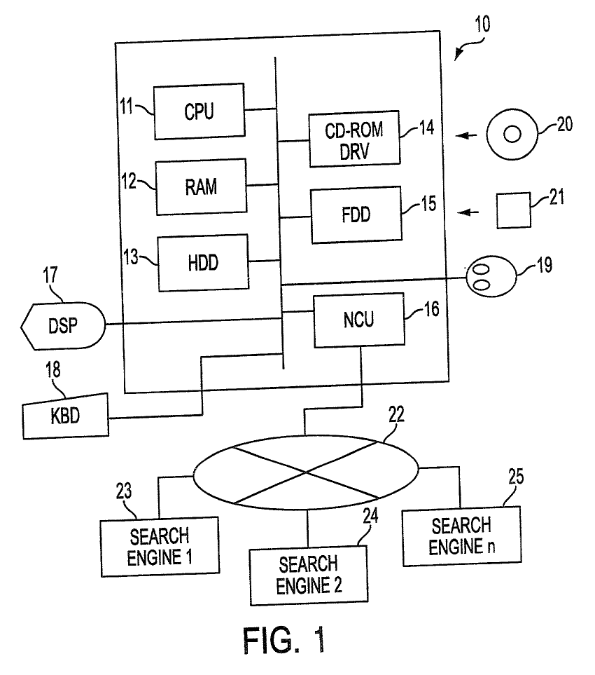

FIG. 1 is a diagram of a client-server network environment on which the present invention may be implemented. According to FIG. 1, computing devices (e.g., computers) are connected via a communication link, such as the Internet, to search engine computers.

In particular, FIG. 1 includes a structure diagram of the typical computing device, for example, a computer (client) 10, on which the present invention may be implemented. As shown in FIG. 1, in one embodiment, the present invention may be implemented on the computer 10, which includes CPU 11, RAM 12, hard disk drive (HDD) 13, CD-ROM drive 14, floppy disk drive (FDD) 15, and a communications control device (unit) 16, such as a network card or a modem.

Display device (unit) 17 is connected to computer 10 by means of a graphics board, which is not featured in the diagram, and the keyboard 18 and the mouse 19 are connected by means of interfaces not shown and a communication line is connected to the communications control device 16.

The RAM 12 is loaded with programs that control the computer and RAM 12 can be used to store the data for the on-screen display on the display 17 as well as for the temporary storage of the data for processing or for the temporary storage of the results of processing by the programs. The display data is displayed on the display 17 by means of the graphics board.

The hard disk drive 13 and the floppy disk drive 15 are devices that record data onto the corresponding recording media, respectively (i.e., the hard disk or floppy disk 21). For example, in the present invention, the hard disk may contain a sentence-analyzing dictionary and a translation dictionary for analysis of the elements of speech in language translation.

The CD-ROM drive 14 reads software (a program) or data recorded on CD-ROM 20.

The communications control device 16 is used for downloading programs or transferring data between other devices by means of communication lines.

Keyboard 18 may be composed of many letter keys and arrow keys for keying in data and to provide instructions to the programs executing on computer 10. Similarly, mouse 19 is used to operate the mouse cursor displayed on the display 17 to give selection instructions using the mouse cursor.

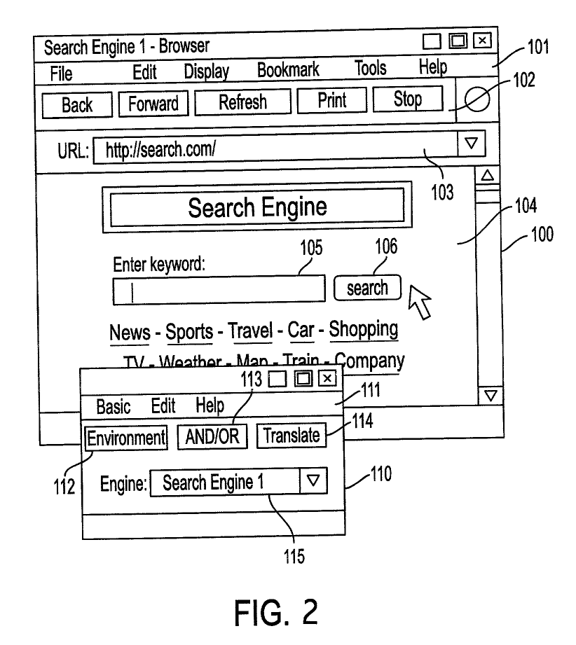

FIG. 2 is a screen display example of an embodiment of present invention implemented on computer 10, the computer executing a web browser (hereafter called a “browser”), which displays a web page. In particular, according to FIG. 2, the present invention may be executed as an application program 110 in a multi-window operating system on a computing device, such as computer 10.

The browser 100 is generally made up of components (perform functions), which include menu 101, tool bar 102, Uniform Resource Locator (URL) display module 103 and content display module 104.

The menu 101 executes all sorts of commands and of those commands, the most frequently used commands are displayed in tool bar 102 as button objects. The user can employ a mouse or other pointing device to select commands from the menu 101 or instruct (click) a button object in the tool bar 102 to command the browser 100 to execute a process.

The URL display module 103 shows the URL data of the web page displayed in the content display module 104. By entering a URL into the URL display module 103 and pressing the Enter key (by using, for example, keyboard 18), an instruction to obtain the web page data corresponding to that URL (generally an HTML document and graphics data) can be issued, and this instruction would cause the content of the web page data obtained to be displayed in the display module 104.

The way to operate each of the aforementioned components of the browser 100 and the actions corresponding to those operations are well known so the details will be omitted here.

Next operation of an embodiment of software system in the present invention is described. The program (computer software) 110 that runs the process of the present invention on a computer is transferred, from either the CD-ROM 20 or the floppy disk 21 using the CD-ROM 14 or the floppy disk drive 15, and stored in advance on the hard disk drive 13. Said program may also be stored on the hard disk drive 13 using a communication line and the communications control device 16. Although, the described exemplary embodiment of the invention stores program 110 on removable recording media or a hard drive, the present invention is not so limited and program 110 may be stored in other types of conventional storage units of computing devices, such as ROM.

The program 110 is loaded into RAM 12 by means of instructions and the process of the present invention as embodied in program 110 is run under the control of the modules of program 110 in computer 10. The browser 100 program is loaded into the RAM 12 in the same way as program 110 and the browser's specific processes are run under the control of the various modules of browser 100 in computer 10. Although, the described exemplary embodiment of the invention executes the modules of program 110 on one client, such as computer 10, the present invention is not so limited and various modules of program 110 can be executed in other clients or processing units connected to the network and communicating with the computer on which program 110 and browser 100 are executing.

As shown in FIG. 1, computer 10 is connected to an external network (the Internet) 22 by means of communication lines and can access the search engines 23-25 over that external network 22. Because much is known about the external network 22 and the conventional search engines 23-25, no detailed description will be provided.

Next, the application 110 of the present invention will be described in more detail. As shown in FIG. 2, the application (program) 110 of the invention is operating as a separate window distinct from the window displayed by browser 100.

Application 110 is composed of the following components: the menu 111, the buttons 112-114 and the combo box 115.

The menu 111 is used to issue all sorts of typical commands (detailed descriptions will be omitted). The buttons 112-114 include the operating environment button 112, the search mode button 113 and the translation button 114.

The operating environment button 112 displays an operating environment dialogue box (not featured) when selected or instructed by a mouse or other pointing device. In the operating environment dialogue box, it is possible to select the browser to be used, to display the search engine setting dialog boxes or change other settings or perform other tasks.

The search mode button 113 is a toggle switch for switching the search mode. In particular, the search mode specifies what sort of logic to use in the search process on the words obtained from the translation process (corresponding to input search terms or keywords input via keyword module 105 of browser 100 in one's native language). There are two modes: an “OR” search mode which will seek web pages corresponding to any one of several words, and “AND” search mode, which seeks web pages that correspond to all of the words. The button is normally set to the “OR” search mode and pressing it will switch it to the “AND” search mode.

The translation button 114 is a button for choosing whether to perform a translation process on the keywords input into keyword input module 105 of browser 100. The translation button 114 is a toggle switch and is normally set so that it does not perform the translation process on the keywords. Pressing or selecting translation button 114 will turn on the translation process on the keywords.

The search engine selection combo box 115 displays a list of the search engines specified in the search engine setting dialogue box and the user may select a search engine from among those displayed. Once the user selects the desired search engine, the application 110 will control browser 100 to display the search page of the selected search engine using content display module 104.

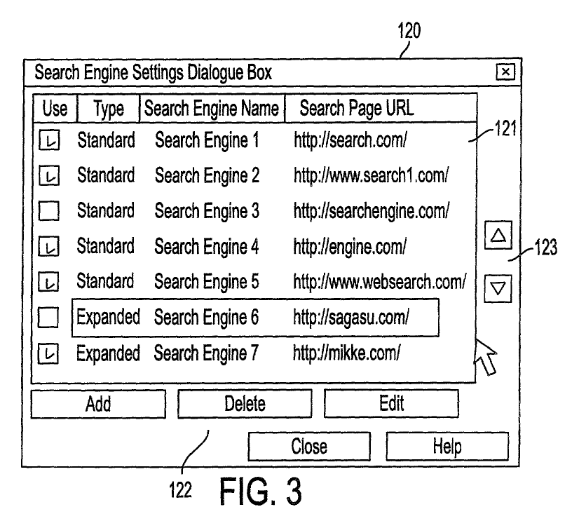

The search engine settings dialogue box will be explained next with reference to FIG. 3, which is a diagram showing the search engine settings dialogue box.

As explained above, search engine settings dialogue box 120 may be opened (displayed) via the operating environment dialogue box. The operating environment dialogue box is displayed by selecting operating environment button 112.

The search engine settings dialogue box 120 is composed of the search engine list, the list display module 121, which displays information pertaining to each search engine, the processing buttons 122, and the order modification button 123, which modifies the display order of the search engine list displayed in search engine selection combo box 115 (FIG. 2).

The list display module 121 provides information (items) relating to the search engines, such as “Use,” “type,” “Search Engine Name” and “Search page URL. ” Therefore, display module 121 displays and administers information pertaining to the search engines.

The “Use” item allows selection of a search engine. In particular, selection of the “Use” box corresponding to a search engine name determines whether the search engine name will be displayed in combo box 115 for selection. When the check box is checked, the corresponding search engine name will be displayed in search engine selection combo box 115. If the check box is not checked, the corresponding search engine name will not be displayed in the search engine selection combo box 115.

The item “Type” indicates the type of search engine administered. Initially, the search engine information is displayed as “standard” and if search engine information is newly added by the user, the search engine information is displayed as “expanded.”

The item “Search Engine Name” indicates the title of the search engine.

The item “Search Page URL” indicates the URL of the search engine, which is the search page from which a data transfer is requested when the search engine name has been selected via the search engine selection combo box 115.

The process buttons 122 may include an “Add” button, a “Delete” button, an “Edit” button, a “Close” button and a “Help” button.

The “Add” button issues instructions to add information for a search engine that the user would like to manage. Activating the “Add” button will start the search page settings wizard described below and the process of adding search engine information will be carried out.

The “Delete” button issues instructions to delete search engine information that is administered. For example, if the desired search engine information displayed in list display module 121 is selected using a mouse or other pointing device and this “Delete” button is activated, the delete process will be carried out on the selected search engine information.

The “Edit” button gives instructions to edit search engine information that is administered. If the desired search engine information displayed in list display module 121 is selected using a mouse or other pointing device and the “Edit” button is activated, the aforementioned search page settings wizard will be started and the modification process will be carried out on search engine information that has already been registered.

The “Close” button is for closing search engine settings dialogue box 120, and the “Help” button issues instructions to display explanations pertaining to search engine settings dialogue box 120.

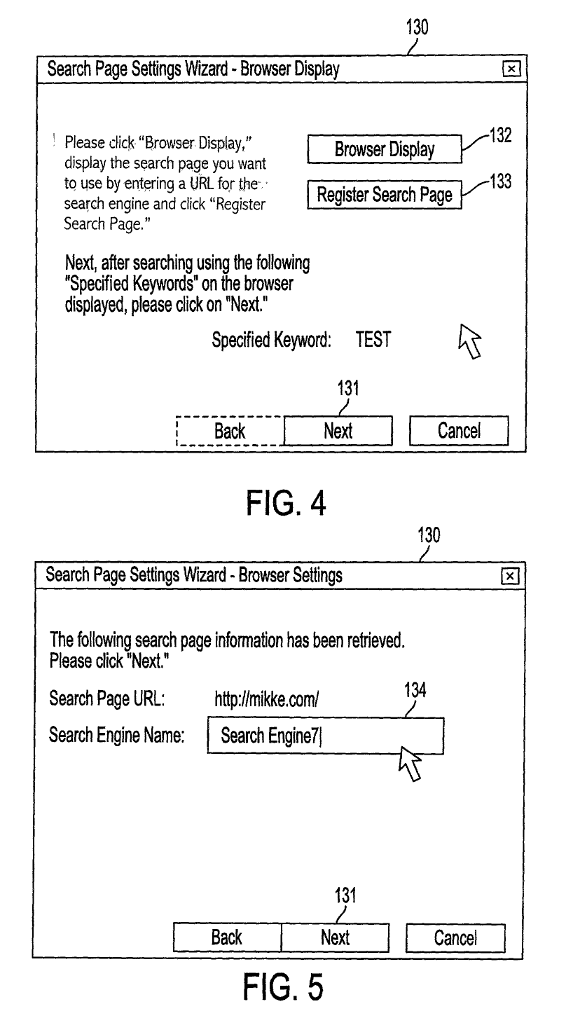

The following is a description of the search page setting wizard 130 that is started, for example, when the aforementioned “Add” and “Edit” buttons are activated. FIG. 4 through FIG. 8 are example screen display diagrams of search page settings wizard 130.

FIG. 9 is a process flow chart for search page setting wizard 130. First, for example, when the “Add” button (in search engine setting dialogue box 120) is activated, search page setting wizard window 130 (shown in FIG. 4) is displayed (A1 in FIG. 9).

At the first stage, process buttons 131, “Browser Display” buttons 132, “Register Search Page” button 133 as well as a description of how to use each of the buttons will be displayed.

The process buttons 131 include buttons, such as a “Back” button, a “Next” button and a “Cancel” button. Activating the “Back” button returns to the screen displayed at the previous stage. The “Next” button advances to the screen displayed at the next stage. There is no previous stage for the first stage so the “Back” button will not work. There is no subsequent stage beyond the final stage, so the “Next” button will be replaced by an “End” button display.

Activating the “Cancel” button displayed at any stage will close (end) search page settings wizard 130.

Process buttons 131 are shared by all the stages, so there will be no description of their functions at other stages.

At the first stage, the search page (i.e., a search engine's URL) to be registered is specified so that browser 100 can request a search to the specified search engine using specified keywords. In particular, with reference to FIG. 4, when the user presses the “Browser Display” button and browser 100 is started (A2 in FIG. 9), the “Register Search Page” button may be clicked to register a search page of a desired search engine after URL or address of the desired search engine has been entered using browser 100.

When selection of the “Register Search Page” button has been detected, the URL of the search page displayed by browser 100 will be obtained and the title of that search page will be obtained and set as the name of the search engine (A3 and A4 in FIG. 9).

Next, the desired keywords (for example, “TEST”) are entered and displayed on browser 100 via keyword input module 105. The search button 106 is used to submit a search process request to the search engine from browser 100 and the search results page will be displayed in browser 100. The entered keywords used for searching are set as the specified keywords.

At this point, the URL of the search results page displayed in URL display module 103 of browser 100 can be obtained. In particular, the keywords contained in the URL of the search results page can be retrieved and the portion of the URL of the search results page not containing the keywords (parameters) can be retrieved as the search page URL (i.e., a search engine's URL) (A5 in FIG. 9). This process of obtaining the search page URL from the URL of the search results page can be used when the URL that is actually performing the search process differs from the search page URL used for entering the keywords.

Activating the “Next” button shifts to the second stage shown in FIG. 5. At the second stage, process buttons 131, search engine name input module 134 and a description of how to use these buttons will be displayed. As shown in FIG. 5, the search page URL obtained in the aforementioned process (first stage, FIG. 4) will be displayed and the search engine name specified using the aforementioned process in search engine name input module 134 will be displayed. It is possible for the user to modify the search engine name displayed in search engine name input module 134 to a preferred name.

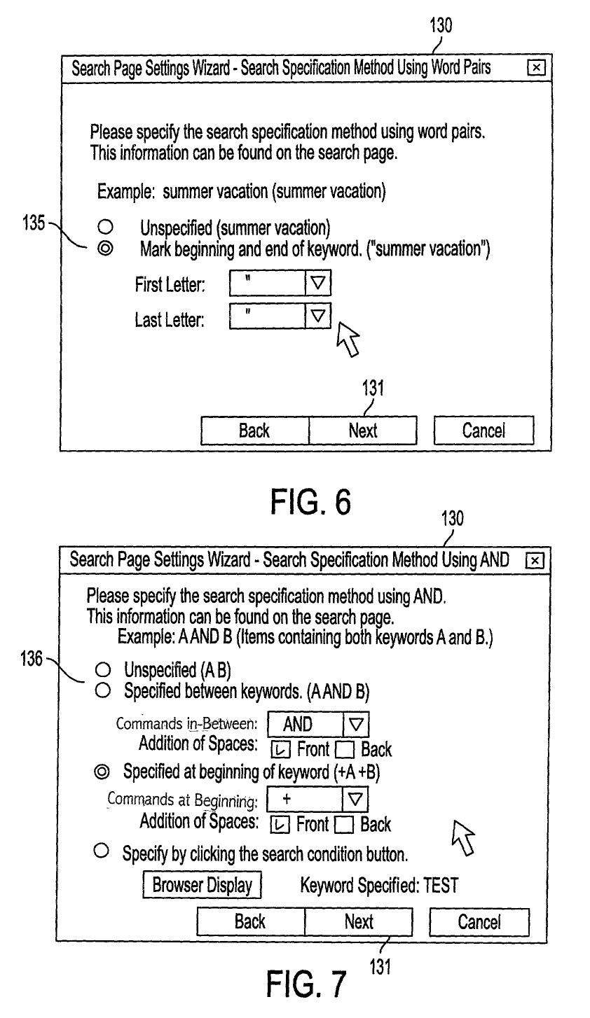

Activating the “Next” button shifts to the third stage shown in FIG. 6. In the third stage, process buttons 131, choice buttons 135 for specifying a search by word pairs (phrases or grouped keywords) and supplementary instructions for specifying the keyword pairs or group of keywords will be displayed (A6 in FIG. 9). This stage is for specifying the format of the keywords derived from translating word pairs input in a native language in keyword input module 105, the derived translated keywords being supplied to the search engine.

In the screen display example of FIG. 6, there are two items to choose from: “Unspecified” and “Mark beginning and end of Keyword”. For example, selecting “Mark beginning and end of Keyword” can specify to use single (or double) quotes on the first and last keywords. In this example, the quotes function as search conditions, search commands or operators. In particular, when the user selects “Unspecified,” the keyword pair search command will not be issued. When selecting the option of using single (or double) quotes on the first and last keywords, the search commands specified in “First Letter” and “Last Letter” input boxes will be added to the front and end of keyword pairs (i.e., first letter of first keyword in the phrase and last letter of last keyword in the phrase). The FIG. 6 example, illustrates that the symbol [“] will be selected for the “First letter” and “Last letter.”

Activating the “Next” button shifts to the fourth stage as shown in FIG. 7. In this stage, other keyword search conditions can be set (A7 in FIG. 9). In particular, process buttons 131, choice buttons 136 for selecting the AND search specification method, and other supplementary explanations for how to specify these items will be displayed. The information in this stage specify the format of the keywords when supplying the search engine with the keywords, for example, in the AND search mode.

In the screen display example of FIG. 7, there are four items to choose from: “Unspecified,” “Specified between keywords,” “Specified at beginning of keyword,” and “Specify by clicking the search condition button.”

When the user selects “Unspecified,” no search commands will be added to the keywords. Selection of “Specify between keywords” adds search commands (search conditions represented as logical expressions or operators in a search query) between keywords of a search query using detailed settings. The detailed settings for the “Specify between keywords” item may include specifying “Commands in-between” (“Intervening Commands”) and the “Addition of Spaces.” The detailed setting “Intervening Commands” specifies search commands to be inserted between keywords. For example, in one embodiment of the present invention there can be three types of commands that can be selected: “AND,” “+” and The “Addition of Spaces” item is for either adding or not adding spaces before or after intervening commands.

Selection of “Specified at beginning of keyword” adds search commands to the beginning of the keywords in the search query using detailed settings. The detailed settings for the “Specified at beginning of keyword” item may include specifying “Commands at Beginning” and “Addition of Spaces”. The detailed setting “Commands at Beginning” specifies search commands to be added to the first part of a keyword. For example, two types of commands may be selected: “+” and “,”. When “Addition of Spaces” is selected, the addition of spaces before or after the search command may be specified.

The choice “Specify by clicking the search condition button” obtains search specification method information after running a search process using browser 100. Selecting this item makes it possible to select the “browser display button” in FIG. 7. By selecting the “browser display” button, browser 100 will be started and the user runs a search process using specific keywords and the techniques (e.g., use of search commands) shown in the supplementary explanations using browser 100. Then search specification method information can be obtained from the search results page. For example, if the AND search mode has been specified in program 110 by selecting search mode button 113, the search specification method information is set according to the AND search command as obtained from the search results page.

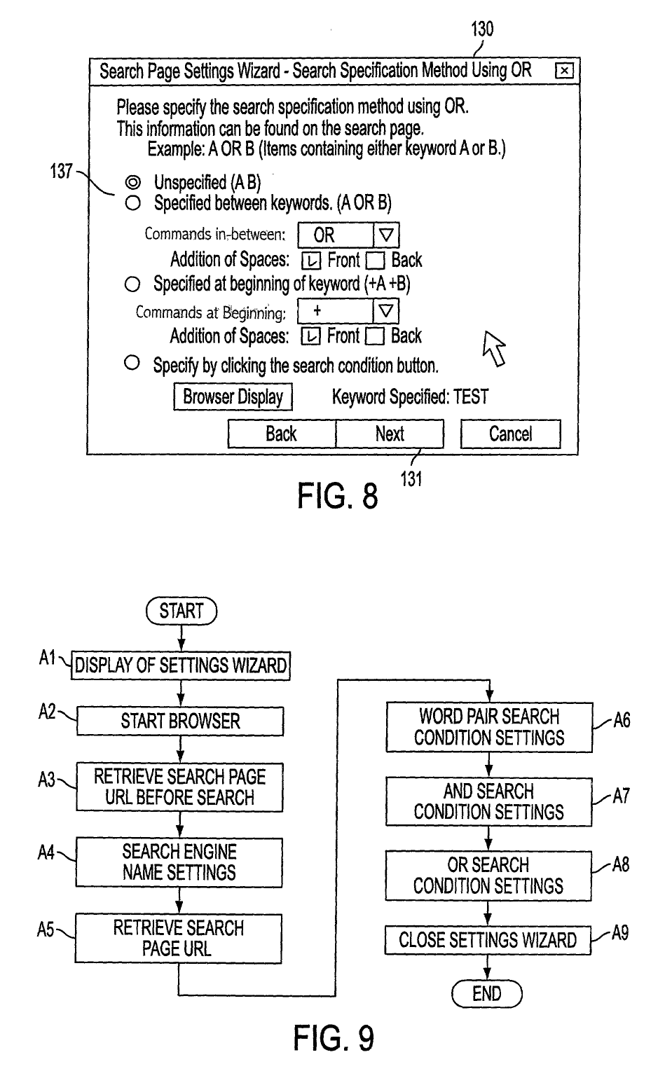

Activating the “Next” button will shift to the fifth stage shown in FIG. 8. In this stage, other keyword search conditions can be set (A8 in FIG. 9). In particular, process buttons 131, choice buttons 137 for selecting the OR search specification method and other supplementary explanations for how to specify these items will be displayed. The information in this stage specify the format of the keywords when supplying the search engine with the keywords, for example, in the OR search mode.

In the screen display example of FIG. 8, there are four items to choose from: “Unspecified,” “Specified between keywords,” “Specified at beginning of keyword,” and “Specify by clicking the search condition button.”

When the user selects “Unspecified,” no search commands will be added to the keywords. Selection of “Specify between keywords” adds search commands (search conditions represented as logical expressions or operators in a search query) between keywords of a search query using detailed settings. The detailed settings for the “Specify between keywords” item may include specifying “Commands in-between” (“Intervening Commands”) and the “addition of spaces.” The detailed setting “Intervening Commands” specifies commands to be inserted between keywords. For example, in one embodiment of the present invention there can be three types of commands that can be selected: “OR,” “+” and “,”. When “addition of spaces” is selected the addition of spaces before or after the search command may be specified.

Selection of “Specified at beginning of keyword” adds search commands to the beginning of the keywords in the search query using detailed settings. The detailed settings for the “Specified at beginning of keyword” item may include “Commands at Beginning” and “Addition of Spaces.” The detailed setting “Commands at Beginning” specifies the search commands to be added to the first part of a keyword. For example, two types of commands may be selected: “+” and “,”. When “Addition of Spaces” is selected, the addition of spaces before or after the search command may be specified.

The choice “Specify by clicking the search condition button” obtains search specification method information after running a search process using browser 100. Selecting this item makes it possible to select the “browser display button” in FIG. 8. By selecting the “browser display” button, browser 100 will be started and the user runs a search process using specific keywords and the techniques (e.g., use of search commands) shown in the supplementary explanations using browser 100. Then search specification method information can be obtained from the search results page. For example, if the OR search mode has been specified in program 110 by selecting search mode button 113, the search specification method information is set according to the OR search command as obtained from the search results page.

Activating the “End” button closes the search page setting wizard window (A9 in FIG. 9). Similarly, when the “Edit” button (processing buttons 122) of the search engine settings dialogue box 120 is activated, the same search page settings wizard will be started so that editing can be done. Because search engine settings can be customized, it is possible to respond to the demands of individual users and make efficient use of many different types of search engines.

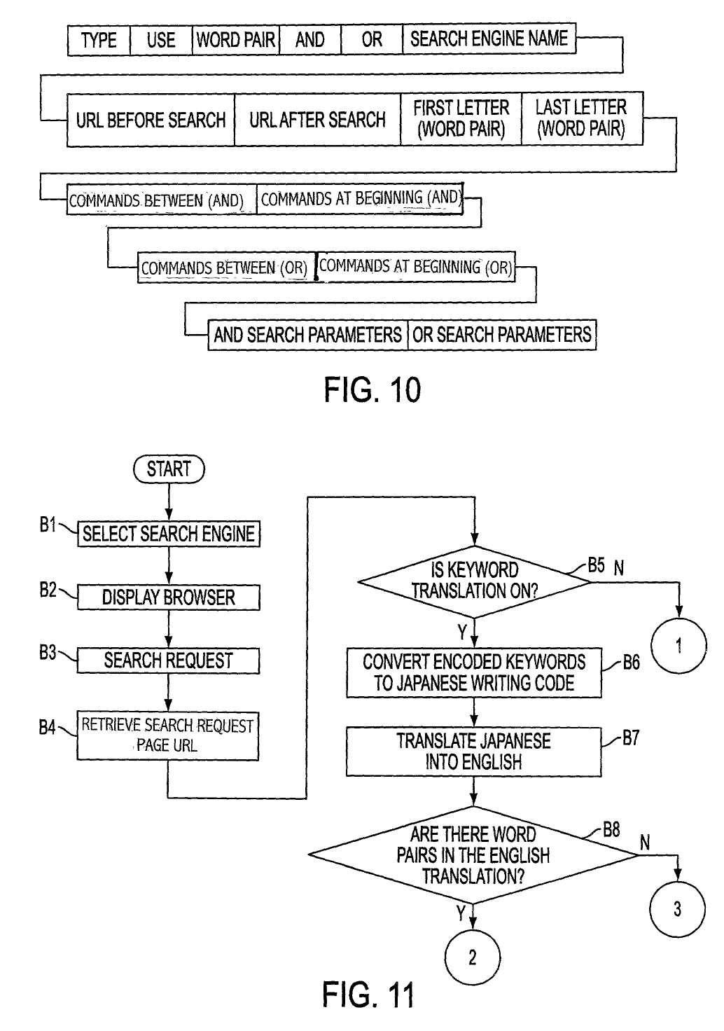

FIG. 10 is a data structure diagram of the search engine settings data, which are set using search engine dialog box 120 and search page settings wizard 130 in the manner described above. The settings data can be generated for each registered search engine and saved, for example, in a file.

As shown in FIG. 10, for each registered search engine, the search engine settings data is composed of the following information: Type, Use, Word Pair Search Specification Method, AND Search Specification Method, OR Search Specification Method, the Search Engine Name, Search Page URL before the Search, Search Page URL after the Search, First Letter of the Word Pair Search, Last Letter of the Word Pair Search, AND Search Specification Method with Commands Between, AND Search Specification Method with Commands at Beginning, OR Search Specification Method with Commands Between, OR Search Specification Method with Commands at Beginning, AND Search Parameters, and OR Search Parameters.

The data structure of the search engine settings data will be described in more detail. The item “Type” stores information (value) indicating either that the search engine data was prepared by the search engine application initially (i.e., “standard” in FIG. 3) or that the search engine settings data has been added or modified by the user.

The item “Use” stores information for indicating whether a search engine will be used, as selected via search engine settings dialogue box 120. The value corresponding to the check in the check boxes in the search engine settings dialogue box 120 are stored as “Use” information.

The item “Word Pairs” stores information corresponding to the selections made or specified in the third stage of the search page setting wizard.

The item “AND” stores information corresponding to the selections made for the AND search specification method in the fourth stage of the search page settings wizard.

The item “OR” stores information corresponding to the selections made for the OR search specification method in the fifth stage of the search page settings wizard.

The item “Search Engine Name” stores the name corresponding to the search engine specified in the second stage of the search page setting wizard.

The item “URL before the Search” stores the URL obtained at the first stage of the search page setting wizard before the search process. When the “Register Search Page” button is clicked, the URL of the web page displayed on browser 100 will be stored. The item “URL after the Search” stores the search page URL retrieved from the search results page obtained through the search process where the browser 100 is employed in the first stage of the search page setting wizard.

The item “First Letter (Word Pair)” stores the specified operator (symbol) specified when the “Mark beginning and end of Keyword” item was selected at the third stage of the search page settings wizard. The item “Last Letter (Word Pair)” stores the specified operator (symbol) specified when the “Mark beginning and end of Keyword” item was selected at the third stage of the search page settings wizard.

The item “Commands Between (AND)” stores the operator selected in the fourth stage of the search page settings wizard for “Commands in-between” item entry when the “Specified between keywords” category was selected. Similarly, the item “Commands at Beginning (AND)” stores the operator symbol selected in fourth stage of the search page setting wizard for “Command at Beginning” item entry when the “Specified at beginning of keyword” category was selected. A space will be added to the data before being stored responsive to the specified “Addition of Spaces” in the fourth stage of the search page setting. In particular, a space can be added before or after the search commands.

The item “Commands Between (OR)” stores the operator selected in the fourth stage of the search page settings wizard for “Commands in-between” item entry when the “Specified between keywords” category was selected. Similarly, the item “Commands at Beginning (OR)” stores the operator symbol selected in fourth stage of the search page setting wizard for “Commands at Beginning” item entry when the “Specified at beginning of keywords” category was selected. A space will be added to the data before being stored responsive to the specified “Addition of Spaces” in fifth stage of the search page setting. In particular, a space can be added before or after the search commands.

The item “AND Search Parameter” stores search command information from the search results page when the “Specify by clicking the search condition button” is specified in the fourth stage of the search page settings wizard. Similarly, the item “OR Search Parameter” stores the search command information from the search results page when the “Specify by clicking the search condition button” is specified at the fifth stage of the search page settings wizard.

Using the search engine settings data, application program 110 controls search engine settings dialogue box 120. The application program 110 also creates the information supplied to the search engine selected.

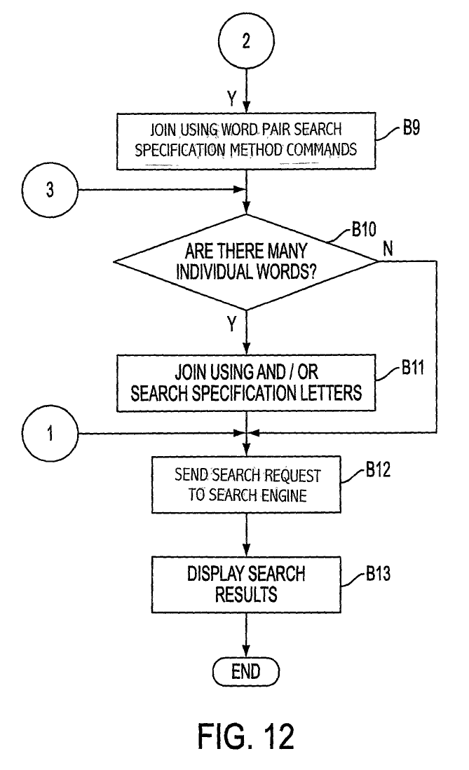

With reference to FIG. 11, FIG. 12 and other figures, description of the process or operation of the present invention as embodied in application program 110 is described. In this example, the user's native language is assumed to be Japanese and a search engine that has web page data written in the English language will be used. FIG. 11 and FIG. 12 are flow charts for application program 110 according to the embodiment of this example.

First, the user selects a search engine using selection combo box 115 of application 110 (B1 of FIG. 11). The application 110 issues a command with the URL of the selected search engine to display via browser 100 the web page (search page) of the selected search engine selected (B2 of FIG. 11). The user can enter into keyword input module 105 of the browser 100 at least one keyword to be used in a search process request and can activate the search button 106 to initiate the search process. Upon activating search button 106, a search process request is sent to the selected search engine (B3 of FIG. 11). In the search request (search query) to be sent to the selected search engine, by issuing a command to the URL of the selected search engine, keyword (or keywords) entered into keyword input module 105 contain the parameters (search conditions and/or operators) encoded using conventional methods for Japanese language.

In particular, application 110 of the present invention hooks and obtains from browser 100 the search request to be issued to the selected search engine (B4 of FIG. 11). Then application 110 detects whether translation should be turned on or has been requested, for example, by pressing the translate button 114 (B5 of FIG. 11). If the translate button 114 is pressed or selected, a Japanese translation process will be performed on the keywords contained in the search request. In this Japanese translation process, the encoded keyword, which is contained in the search request, will be converted to Japanese letter (writing) code (B6 in FIG. 11). The spaces will all be deleted from the Japanese letter code obtained from the above Japanese translation process and an English translation process is performed on the obtained Japanese letter code (B7 in FIG. 11). In this English translation process, the parts of speech will be analyzed using a dictionary of grammatical analysis and a translation dictionary will be used to perform the translation on the results of the analyses. Only the first candidate corresponding to each word of the Japanese obtained in this translation will be used as the English translation. The dictionary of grammatical analysis and the translation dictionary may be conventional.

Then, the results of this English translation will be checked for existence of word pairs (phrases or grouped keywords) (B8 in FIG. 11). If there are word pairs, English words making up the word pairs will be joined using the word pair search specification commands set for the selected search engine as described above in connection with search engine settings dialogue box 120 and search page settings wizard 130 (B9 in FIG. 12).

Further, there will be a check to see if there is more than one English word in the English translation (B10 in FIG. 11). If there are more than one words, the AND search specification method information and the OR search specification method information set for the selected search engine will be used to create the parameters for joining the English words. For example, as described above in connection with search engine settings dialogue box 120 and search page settings wizard 130, the information stored in the AND Search Specification Method and the OR Search Specification Method items of the selected search engine settings data (FIG. 10) will be used to create the parameters for joining the English words. The search specification method information will be encoded, then substituted (or added) as the search query parameters and supplied to the search engine (B12 in FIG. 12).

In the event that keyword translation has not been specified, the search query from browser 100 will be supplied to the search engine without modification. Therefore, in the exemplary embodiment, the search process will be carried out in the search engine in accordance with a search request from a client computer. The search request may be translated (as the case may be) and supplied to the search engine from the client. The search results will be supplied to browser 100 of the client and displayed by content display module 104 of browser 100 (B13 in FIG. 12).

In this embodiment, the configuration assumes that Japanese is the native language to be translated into English, but this does not serve to limit the language types or language combinations. Although an exemplary embodiment of the invention as described above is implemented in a computer connected to the Internet, the invention is not limited to use with any particular type of computer and network, including any communication protocol and client-server architecture, and the present invention may be used with any device having software processing capability communicating with other computing/processing devices over any network (private, Intranet, or public, such as Internet).

The many features and advantages of the present invention are apparent from the detailed specification and thus, it is intended by the appended claims to cover all such features and advantages of the system which fall within the true spirit and scope of the invention. Further, numerous modifications and changes will readily occur to those skilled in the art from the disclosure of this invention. It is not desired to limit the invention to the exact construction and operation illustrated and described; accordingly, suitable modification and equivalents may be resorted to, as falling within the scope and spirit of the invention.

What is claimed is:

1. A processing device connected to a network and equipped with a browsing unit that displays supplied web pages on a display unit of the processing device, the processing device comprising:
a detection unit to communicate with the browsing unit and to detect whether a specific process is required for data input into a web page displayed by the browsing unit;
a processing unit to communicate with the detection unit and to execute specific processes on the data input into the web page responsive to a detection result by the detection unit; and
a control unit to communicate with the processing unit and to use results of the specific processes to process requests from the web page.

2. The processing device according to claim 1, wherein a search server connected to the network supplies the web pages and the processing unit translates the data input into the web page and the control unit sends a processing request to the search server using the translated data.

3. The processing device according to claim 2, further comprising
an administration unit to manage search servers;
a selection unit to select a search server from the search servers; and
a display control unit to cause the browsing unit to display a web page of the selected search server.

4. The processing device according to claim 3, further comprising a setting unit to add or delete a search server managed by the administration unit.

5. A computer-readable recording medium storing at least one computer program executed by a computer connected to a network, the computer having a browsing module displaying on a display unit of the computer supplied web pages, and said at least one computer program, comprising:
a detection module to detect whether a specific process is required for data input into a web page displayed by the browsing module;
a processing module to execute specific processes on the data responsive to a detection result by the detection module; and
a control module to use results of the specific processes when processing requests using the web page.

6. The computer-readable recording medium according to claim 5, wherein a search server connected to the network supplies the web pages and the processing module translates the data input into the web page and the control module sends a processing request to the search server using the translated data.

7. The computer-readable recording medium according to claim 6, further comprising
an administration module to manage search servers;
a selection module to select a search server from the search servers; and
a display control module to cause the browsing module to display a web page of the selected search server.

8. The computer-readable recording medium according to claim 7, further comprising a setting module to add or delete a search server managed by the administration module.

9. A processing device connected to a network and equipped with browsing means for displaying supplied web pages on display means of the processing device, the processing device comprising:
detection means for detecting whether a specific process is required for data input into a web page displayed by the browsing unit;
processing means for executing specific processes on the data input into the web page responsive to a detection result by the detection means; and
control means for using results of the specific processes to process requests from the web page.

10. The processing device according to claim 9, wherein a search server connected to the network supplies the web pages and the processing means translates the data input into the web page and the control means sends a processing request to the search server using the translated data.

11. A device connected to a network and displaying web pages supplied from a search server connected to the network, the device comprising:
a processor, to determine whether to translate a search query input into a web page, to translate the search query responsive to the determination, and to send the translated search query to the search server.

12. The device according to claim 11, wherein the processor further administers a list of search servers, selects a search server from the list of search servers, and displays a web page of the selected search server.

13. The device according to claim 12, wherein the processor further administers search query settings of each search server.

14. A client-server system, comprising
a search server connected to a network and to supply web pages;
a client connected to the network and comprising a processor, to display web pages supplied from the search server, to determine whether to translate a search query input into a web page, to translate the search query responsive to the determination, and to send the translated search query to the search server.

15. The device according to claim 14, wherein the processor further administers a list of search servers, selects a search server from list of search servers, and displays a web page of the selected search server.

16. The device according to claim 15, wherein the processor further administers search query settings of each search server.

17. A method of searching on a network web page information in one language via a search query in another language, comprising:
determining in a device connected to the network whether to translate a search query input into a web page, the search query being in one language to be sent to a search server connected to the network and the search server containing web page information in another language;
translating in the device the search query responsive to the determination; and
sending from the device the translated search query to the search server.

18. A device connected to a network and displaying web pages supplied from a server connected to the network, the device comprising:
a processor, to determine whether to perform a process on data input into a web page by a user, to perform the process responsive to the determination, and to send to the server processing requests of the web page using results of the process.
